(19) United States
(12) Patent Application Publication
(10) Pub. No.: US 2008/0174943 A1
(43) Pub. Date: Jul. 24, 2008

(54) Portable Electronic Apparatus

(76) Inventors: Kiyoshi Hirasawa, Tokyo (JP); Tomoyoshi Hamada, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/584,505

(22) PCT Filed: Dec. 3, 2004
(86) PCT No.: PCT/JP2004/018445

§ 371 Date: Oct. 29, 2007

(30) Foreign Application Priority Data
Dec. 25, 2003 (JP) 2003-431443
Oct. 4, 2004 (JP) 2004-291703

(51) Int. Cl. G06F 1/16

(52) U.S. Cl. 361/681

(57) ABSTRACT

A portable electronic apparatus, which has a simple structure and the performance of visual appearance thereof in an operation state with a display section being adjusted in the height and angle thereof is not decreased, and provides the same comfort as an ordinary TV set while viewing TV images or the like. A main unit (100), a lid section (200) containing a display unit (210) so as to cover the main unit, and a telescopic arm section (300) of which one end is rotatably pivoted in the rear end portion of the main unit, and the other end thereof is rotatably pivoted in the rear portion of the lid section (200) are provided. The main unit (100) of the portable electronic apparatus is provided with locking part (120) for locking the lower edge portion of the lid section (200) in the upper portion on the front-end side thereof.

### TECHNICAL FIELD

The present invention relates to a portable electronic apparatus such as a notebook type personal computer, PDA apparatuses and portable DVD display units; and more particularly to a portable electronic apparatus in which a lid section is mounted on the portable electronic apparatus and fitted with a display unit height, angle and position of which are capable of being adjusted with respect to the main body of the apparatus.

### BACKGROUND ART

In a conventional common information processing apparatus such as a notebook type personal computer, it is arranged so that a keyboard is disposed in the upper surface of the main body, and the keyboard section is covered by a lid section, which is movable to open/close via hinges disposed at the rear end of the main unit. In the arrangement as described above, by turning the lid section to adjust the angle thereof, it is possible to adjust the image plane of the display unit to an angle at which the image plane can be suitably seen. However, in a manner other than the above, it is not possible to change the height, position, angle and the like of the image plane of the display unit. As a result, during ordinary operation seeing the display unit disposed in the lid section, an operator has to maintain a posture with his/her neck tilted forward for a long period of time. That causes a fatigue such as stiffness on the shoulder.

In order to solve the above problem, for example, a patent document 1 discloses the following technique. That is, a movable slider is provided inside an outer cover, which is supported so as to open and close via a hinge member at one of both ends of the main body, and it is arranged so that the lower end of a display unit on the inner cover is supported rotatably by the movable slider; thereby, the height and angle of the display unit can be changed.

Also, a patent document 2 discloses the following technique. That is, a problem of the positioning space in the patent document 1 is solved, and the adjustment of the height and angle of the display section can be made without depending on the state of the backrest of the front seat in an airplane etc. In particular, at the both sides of a lid, which is pivoted in a freely opening/closing way at the rear end of the main body, frames formed with guide grooves are disposed; and further, in a central area in the height direction of the display section, hinge units are provided; and the hinge units are attached to the slide plates, which are movable in the height direction being guided by the guide grooves in the above frames. Owing to this arrangement, it is made possible that the hinge units are positioned higher than the frame. Thus, even when the space is limited, the height and angle of the display section can be changed.

[Patent document 1] Japanese Patent Application Laid-Open No. 10-326121 (1998)

[Patent document 2] Japanese Patent Application Laid-Open No. 2002-023650

### DISCLOSURE OF THE INVENTION

However, in the above techniques disclosed in the patent documents 1 and 2, although the height and angle of the display unit or display section is changeable, in both cases, the outer cover or lid, which is pivoted in a freely opening/closing way at the rear end of the main unit, and the display unit or display section are arranged separately. Therefore, the structure becomes complicated, and further, the performance of visual appearance in a state of operation is undesirably decreased. Furthermore, since the movable range in the front and rear directions of the display section is small, it is not possible that, in a state that the display section is positioned in front of the keyboard section, the display section is adjusted to an ordinary viewing angle.

Further, in these days, from personal computers as a conventional subject to display characters, personal computers as a multimedia station, which outputs images and voices, are getting popular. In portable electronic apparatuses such as notebook type personal computers also, images of TV programs can be viewed and TV games can be enjoyed therewith. When the portable electronic apparatus such as notebook type personal computer or the like is used for viewing TV images or the like as described above, in place of keyboard, a remote controller or a controller for TV game is used to operate the same. It is preferred that, same as an ordinary TV set, the display unit is changed into a state that the keyboard is not seen.

Accordingly, a first object of the present invention is to provide a portable electronic apparatus, which has a simple structure, and the performance of visual appearance thereof in an operation state with a display section being adjusted in the height and angle thereof is not decreased. Another object of the present invention is to provide a portable electronic apparatus, which provide the same comfort as an ordinary TV set while viewing TV images or the like.

In order to achieve the above object, a portable electronic apparatus according to an aspect of the present invention comprises a main unit, a lid section fitted with a display unit for covering the main unit, and an arm section pivoted rotatably at one end thereof in the rear end portion of the main unit for supporting the lid section rotatably and adjustably in height position.

Here, the arm section may be telescopic.

Here, the main unit of the portable electronic apparatus is preferably provided with, in the upper portion on the front end side thereof, locking means for locking the lower edge portion of the lid section.

The arm section preferably has a clearance for, when the lid covers the main unit, allowing the both to be parallel to each other.

Further, the arm section preferably includes a slide mechanism and a one-way brake mechanism that provides a small resistance in the extension direction of the arm section and a brake force in the retraction direction thereof.

Furthermore, the arm section may contain a cable for connecting the main unit and the display unit, and have a winding mechanism for the cable.

The arm section may comprise a first arm section on the main unit side and a second arm section on the lid section side, the slide mechanism may include a rack, which is attached to either one of the first arm section and the second arm section, and a pinion, which is rotatably attached to the other of the first arm section and the second arm section so as to mesh with the rack, the one-way brake mechanism, which provides a small resistance in the extension direction of the arm section and a brake force in the retraction direction thereof, may be driven by the pinion.

Here, the winding mechanism of the cable may be driven by the pinion.

Further, the slide mechanism may be driven by an electric motor.

Furthermore, a changeover switch, which functions when the lower edge portion of the lid section is locked by the locking means, may be included.

Further, the lid section preferably includes a pocket of substantially rectangular shape formed in the rear portion, the telescopic arm section includes the first arm section on the main unit side and the second arm section on the lid section side, the first arm section can be received in the second arm section in a telescopic manner, and the second arm section can be received in the pocket.

Moreover, the arm section may be pivoted rotatably at the other end thereof being interposed by a slide mechanism provided in the rear portion of the lid section so as to slide thereon.

Further, the slide mechanism may include a pair of guide rails provided in the rear portion of the lid section and a pair of sliders, which slide along the pair of guide rails respectively, and further include a holding means for holding the slider at a predetermined position.

Here, the holding means preferably comprises dimples formed at predetermined intervals in at least one of the pair of guide rails and a detent ball provided in the slider.

According to an aspect of the present invention, a main unit, a lid section fitted with a display unit so as to cover the main unit, and an arm section rotatably pivoted at one end thereof in the rear end portion of the main unit, which supports the lid section rotatably and adjustably in its height, are provided. Accordingly, only by moving the lid section, which is fitted with the display unit, the height and angle of the display unit can be adjusted to a position to be suitably seen, and the performance of visual appearance thereof at that time is not decreased. Particularly, in the state that the lower edge portion of the lid section is positioned in the upper portion of the front-end side of the main unit, the display unit can be raised up to right angle or close to substantially right angle.

Here, according to an embodiment in which the main unit is provided with, in the upper portion on the front end side thereof, locking means for locking the lower edge portion of the lid section, when the lid section is locked, the upper surface of the main unit is hidden by the lid section fitted with the display unit; and at the same time, the display unit can be raised up at right angle or close to substantially right angle with respect to the main unit. Accordingly, a portable electronic apparatus, which is the same as an ordinary TV set, can be obtained.

According to an embodiment in which the arm section includes a clearance for, when the lid section covers the main unit, allowing the both to be parallel to each other, in the state that the portable electric apparatus is not used, the state of the apparatus is the same as that of an ordinary portable electronic apparatus.

According to another aspect of the invention in which the arm section is telescopic and includes the slide mechanism and the one-way brake mechanism that provides a small resistance in the extension direction of the arm section and a brake force in the retraction direction thereof, the height of the lid section fitted with the display unit can be raised with a moderate force without using additional force, and the display unit can be readily held at a height position.

According to further aspect of the invention, in which the arm section contains a cable for connecting the main unit and the display unit, and has a winding mechanism for the cable, the performance of visual appearance is not decreased and the cable can be prevented from being entwined.

According to further aspect of the invention, in which the arm section comprises a first arm section on the main unit side and a second arm section on the lid section side, the slide mechanism include a rack, which is attached to one of either the first arm section or the second arm section, and a pinion, which is rotatably attached to the other of either the first arm section or the second arm section so as to mesh with the rack, the one-way brake mechanism, which provides a small resistance in the extension direction of the arm section and a brake force in the retraction direction thereof, is driven by the pinion, the arm section and slide mechanism can be formed into a simple structure, and the one-way brake mechanism can be driven easily.

Here, according to another aspect of the invention in which the winding mechanism of the cable is driven by the pinion, extra drive means for the winding mechanism of cable is not needed resulting in a simple structure.

According to further aspect of the invention in which the slide mechanism is driven by an electric motor, the height of the display unit can be readily adjusted.

According to further aspect of the invention in which the changeover switch that functions when the lower edge portion of the lid section is locked by the locking means, is included, user friendly performance is obtained.

According to further aspect of the invention, in which the arm section is pivoted rotatably in the rear area of the lid section being interposed by a slide mechanism attached at the other end thereof so as to slide, a mechanism for allowing the display unit to be adjusted at a position easy to monitor in its height and/or angle can be achieved with a simple structure.

The above and other objects, effects, features and advantages of the present invention will become more apparent from the following description of embodiments thereof taken in conjunction with the accompanying drawings.

### BRIEF DESCRIPTION OF THE DRAWINGS

FIG. 1 is a perspective view showing a notebook type personal computer according to a first embodiment of the invention in a state that a lid is closed;

FIG. 2 is a side view including a partial section showing the notebook type personal computer according to the first embodiment of the invention in a state that the lid is closed;

FIG. 3A is a perspective view of the notebook type personal computer according to the first embodiment of the invention viewed from the front side thereof in a state that the lid is opened, and FIG. 3B is a perspective view perspectively showing a junction portion formed in a lower edge portion of the lid;

FIG. 4 is a perspective view showing the notebook type personal computer according to the first embodiment of the invention in a state that the lid is opened and an arm section is extended viewed from the front side thereof;

FIG. 5 is a perspective view showing the same state as that in FIG. 4, viewed from the rear side thereof;

FIG. 6 is a side view including a partial section showing the same state as that in FIG. 4;

FIG. 7 is a perspective view showing the arm section viewed from the front side thereof;

FIGS. 8A, 8B are views respectively showing the same arm section; FIG. 8A is a side view perspectively showing the arm section, and FIG. 8B is a rear view of the arm section in which a part thereof is taken away;

FIG. 9A is a sectional view taken along the line IXA-IXA in FIG. 8B, FIG. 9B is a sectional view taken along the line IXB-IXB in FIG. 8B, and FIG. 9C is a sectional view taken along the line IXC-IXC in FIG. 8B;

FIG. 10 is a perspective view of the notebook type personal computer according to the first embodiment of the invention viewed from the front side thereof showing a state that the lower edge portion of the lid is locked in the upper portion on the front end side of a main unit;

FIG. 11 is a perspective view of the notebook type personal computer according to the first embodiment of the invention viewed from the rear side thereof showing a state that the lower edge portion of the lid is locked in the upper portion on the front end side of a main unit;

FIG. 12 is a side view including a partial section showing the same state as that in FIG. 10 and FIG. 11;

FIG. 13 is a perspective view of a portable DVD display unit according to another embodiment of the invention viewed from the front side thereof showing a state that the lower edge portion of the lid is locked in the upper portion on the front end side of the main unit;

FIG. 14 is a perspective view of a notebook type personal computer in accordance with a second embodiment of the present invention in a state that a lid section is opened and lifted up viewed from the backside thereof, from which a part of the back face of the lid section is taken away;

FIG. 15A is a perspective view of an arm section in accordance with the second embodiment of the present invention viewed from the front side thereof; and FIG. 15B is a partial enlarged sectional view thereof; and

FIG. 16 is a partial sectional side view of the notebook type personal computer in the same state as that in FIG. 14.

### BEST MODE FOR CARRYING OUT THE INVENTION

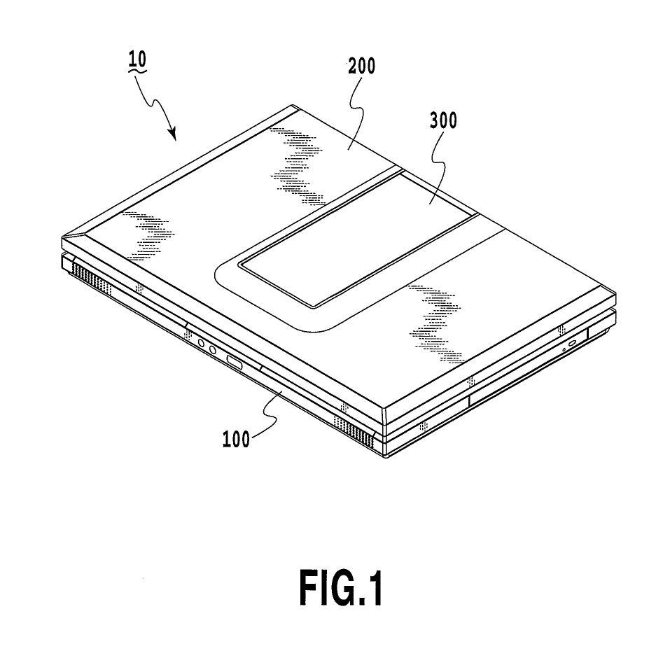

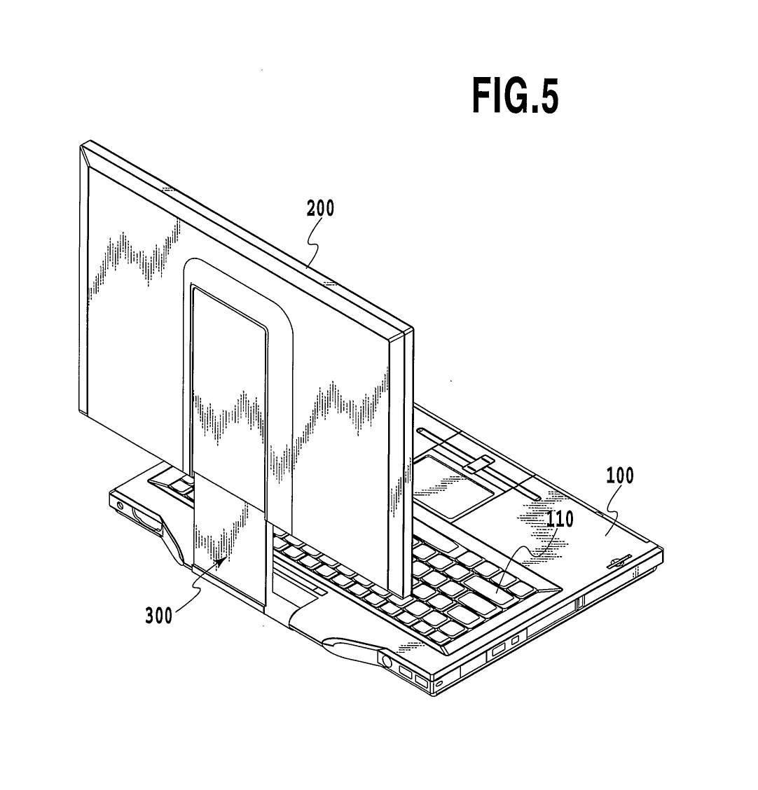

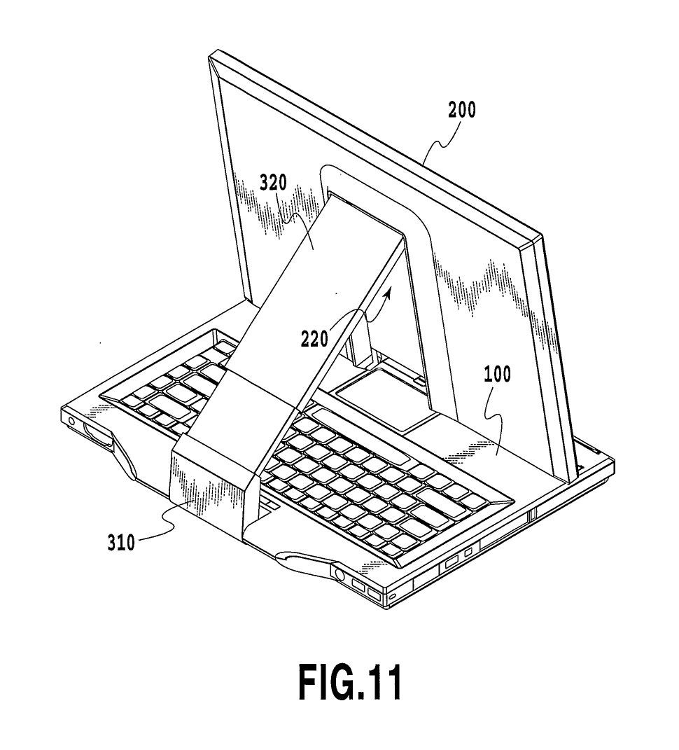

Now, referring to the attached drawings, embodiments of the present invention will be described. First, as a first embodiment of the invention, an embodiment in which the invention is applied to a notebook type personal computer (hereinafter, referred to as notebook type PC) 10 will be described with reference to FIG. 1 through FIG. 12. In the following descriptions, when indicating the positional relationship such as “upper” and “lower” or “right” and “left” directions, a state in which a lid section is opened with respect to the main unit is used as the reference; and it is defined that the side of a display unit facing to an operator is the front side thereof. Here, in the drawings, a notebook type PC 10 according to this embodiment comprises a main unit 100, a lid section 200, in which a display unit is fitted so as to cover the main unit 100, and a telescopic arm section 300, of which one end is rotatably pivoted in the rear end portion of the main unit 100, and the other end thereof is rotatably pivoted in the rear portion of the lid section 200.

The main unit 100 is provided with a keyboard 110 disposed on the upper surface thereof, and contained therein are a system board mounted with a CPU, a memory, peripheral controller chips and the like, and peripheral devices including a TV tuner, a hard disk drive (HDD), and storing devices such as a CD-ROM drive and a DVD drive.

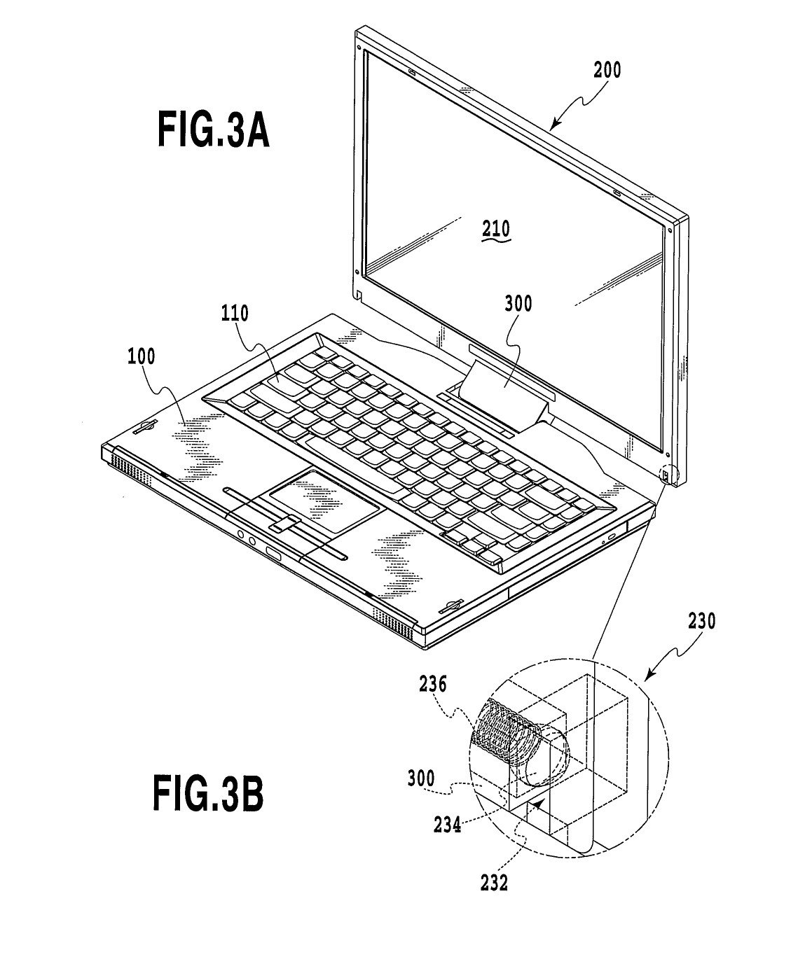

The lid section 200, which covers the main unit 100 is, as shown in FIGS. 3A and 3B and others showing a state that the lid section 200 is opened, provided with a display unit 210, which is comprised of a liquid crystal display and the like, fitted in the front side thereof. Formed in the central area of the rear portion of the lid section 200 from the lower edge portion toward the central upper area is a substantially rectangular-shaped pocket 220 for receiving the arm section 300.

In the telescopic arm section 300, one end thereof is pivoted rotatably by a hinge mechanism H1, which will be described later, at the rear end portion of the main unit 100; and the other end thereof is pivoted rotatably by a hinge mechanism H2 at the upper end portion of the pocket 220 in the rear portion of the lid section 200. In this embodiment, the arm section 300 comprises a first arm section 310 on the main unit 100 side and a second arm section 320 on the lid section 200 side; and it is arranged so that the first arm section 310 is received in a nested manner within a cover member 322 of the second arm section 320 so as to extend and retract telescopically.

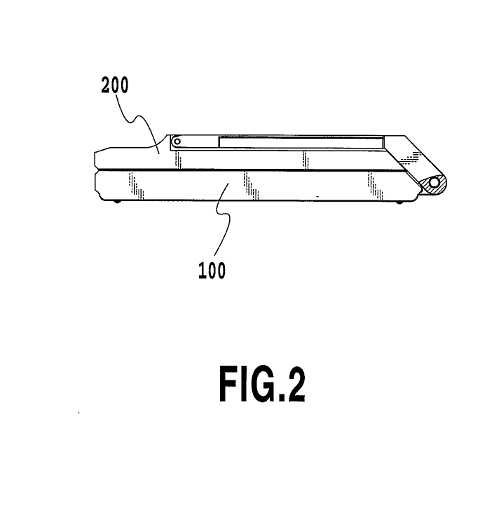

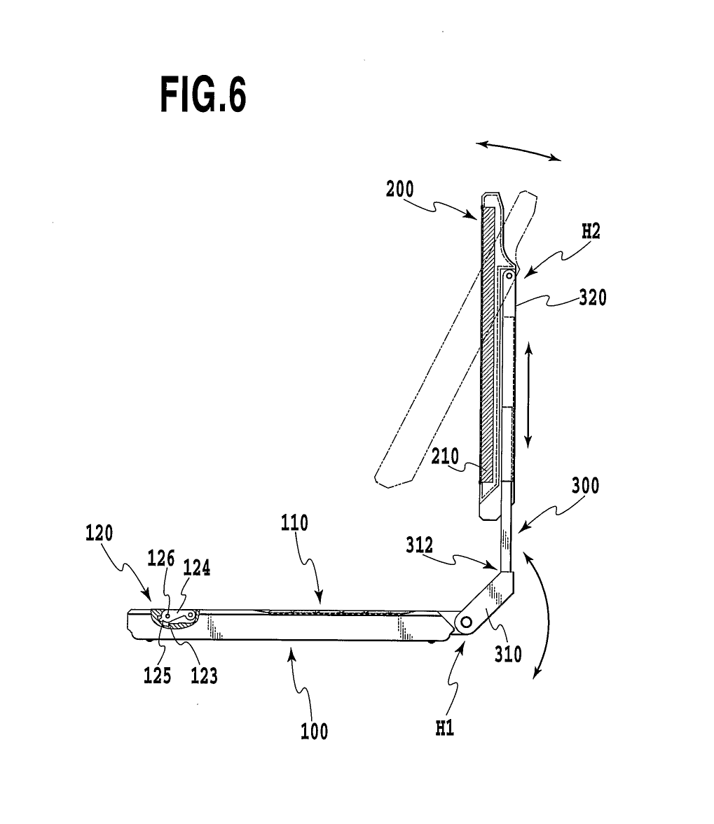

When the notebook type PC 10 is not used and the lid section 200 covers the main unit 100, in order to allow the both to be parallel to each other, a clearance 312 is formed in the first arm section 310 as shown in FIGS. 1 and 2. In this embodiment, the clearance 312 is formed as a bending portion (refer to FIG. 6).

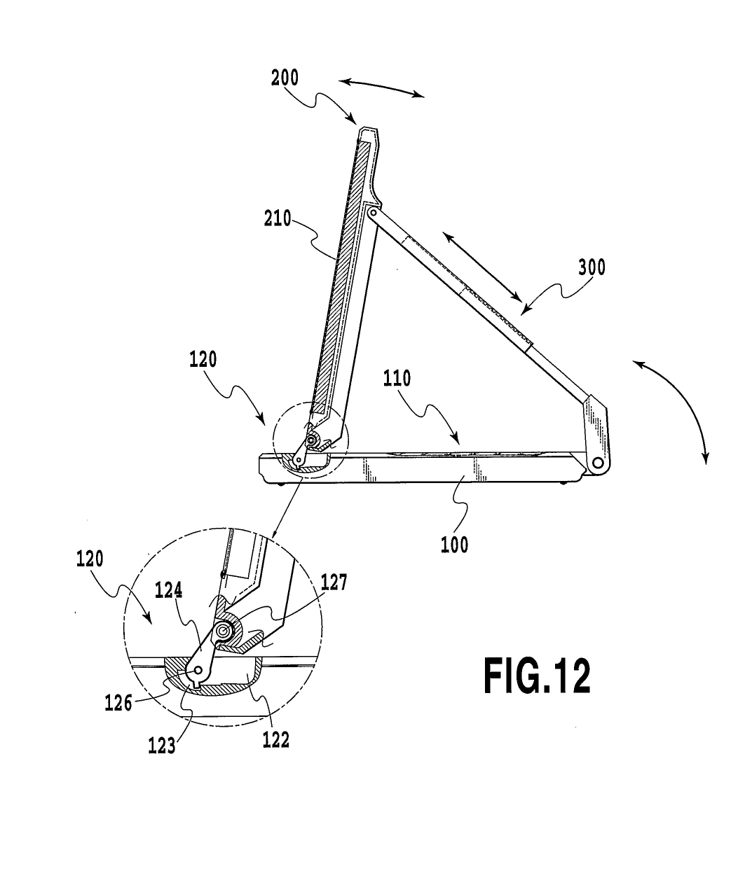

Here, first of all, referring mainly to FIG. 3A, FIG. 3B, FIG. 6 and FIG. 12, a locking means 120, which is formed in an upper portion on the front end side of the main unit 100, will be described. In this embodiment, the main unit 100 is provided with the locking means 120 at the both sides in the upper portion on the front end side thereof. In a slot 122, which has an inflated portion in the central area thereof viewed from top, it is arranged so that a locking bracket 124 is supported by a pin 126 rotatably a predetermined angle. Formed at one end of the locking bracket 124, is a projection 125, which is inserted in a guide groove 123 having a sector-like section formed in the bottom face of the slot 122. It is arranged so that the projection 125 comes into contact with the both ends of the guide groove 123 having a sector-like section, thereby the rotation angle of the locking bracket 124 is limited. That is, as shown in FIG. 3A and FIG. 6, in a state that the locking bracket 124 is not used, the locking bracket 124 is held so as to be substantially even with the upper surface of the main unit 100. And when the locking bracket 124 is used, as shown in FIG. 12, the locking bracket 124 is arranged so as to turn a predetermined angle (substantially 90°) and to be raised being limited by the sector-like guide groove 123. The other end of the raised locking bracket 124, a ball socket 127, which has a ball-like recess, is provided.

On the other hand, in the lower edge portion of the lid section 200 fitted with the display unit 210, an engaging means 230 is provided in a relationship corresponding to the above-described locking means 120. In this embodiment, a slot 232 is formed in the front portion of the lower end of the lid section 200. On the one sidewall in the slot 232, a detent ball 234 is provided being urged by a spring 236 so as to come out and retract therefrom freely.

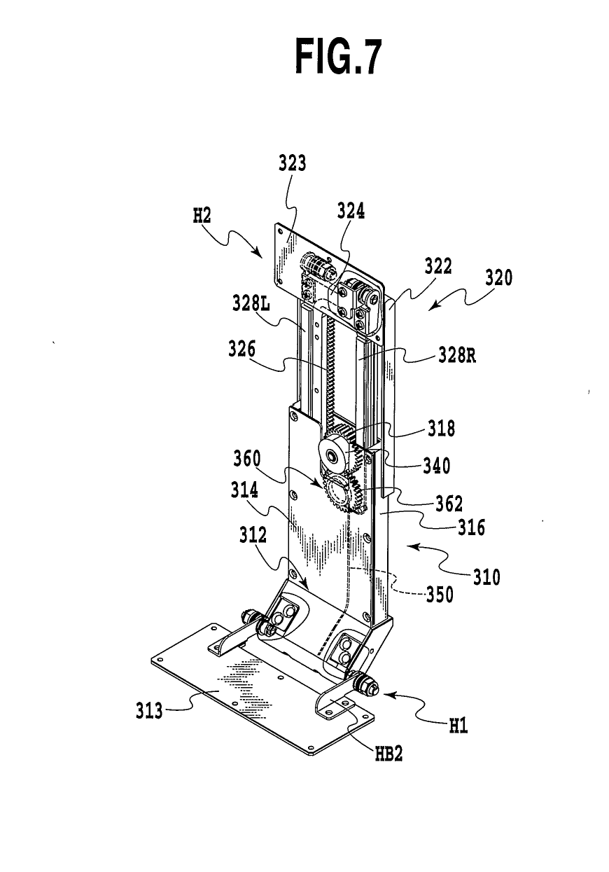

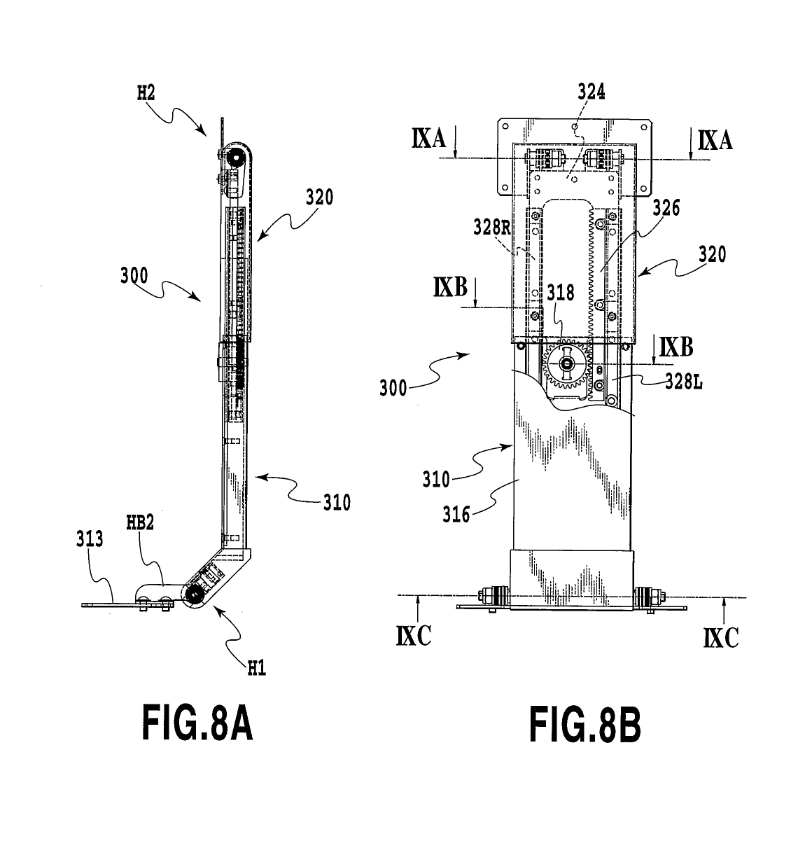

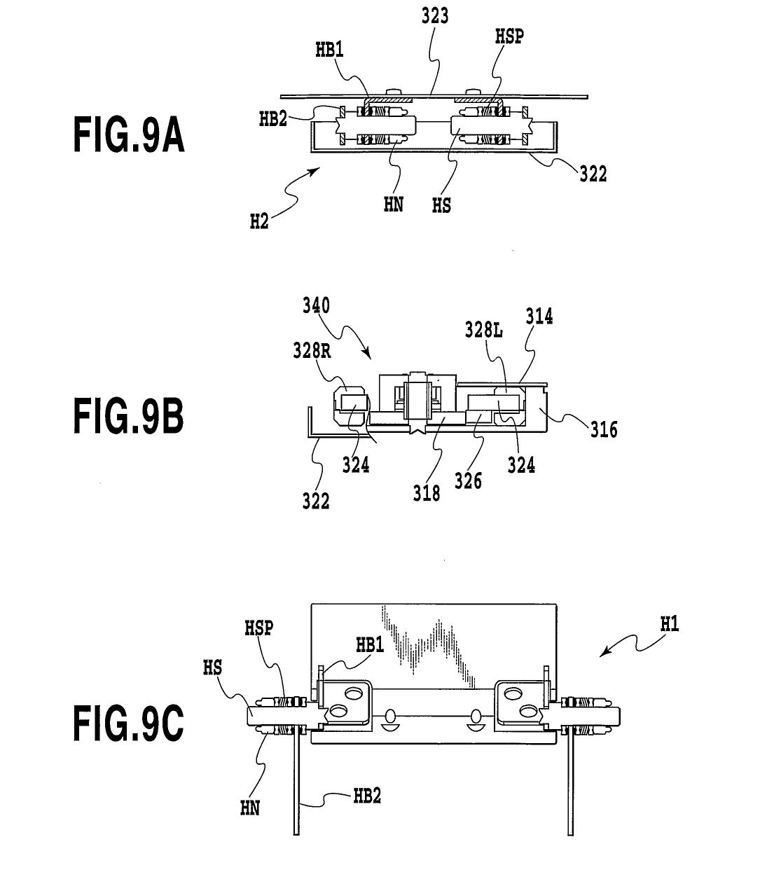

Next, the slide mechanism in the above-mentioned telescopic arm section 300 will be described with reference mainly to FIG. 6, FIG. 7, FIG. 8A, FIG. 8B and FIG. 9B. In this embodiment, the first arm section 310, in which the clearance 312 is formed as the bending portion as described above, comprises a flat base plate 314 made of a steel plate and a cover member 316, which is mounted on the flat base plate 314, having a U-shaped in cross section made of an aluminum die cast so as to form a hollow structure as the basic structure. The cover member 316 of the first arm section 310 has different thickness with the above bending portion as the boundary. Thereby, it is arranged so that, when the first arm section 310 is accommodated in the cover member 322 of the second arm section 320 in a nested manner, no ramp is formed.

On the other hand, in the second arm section 320, the above-cover member 322 is attached to a rectangular frame plate 324 made of an aluminum die cast. Attached to the frame plate 324 parallel to each other are a rack 326, a left guide rail 328L and a right guide rail 328R. The left guide rail 328L and the right guide rail 328R are formed with a resin into U-shaped in cross section so as to sandwich the frame plate 324 from the front and the back thereof; and are held in right and left guide grooves, which are formed along the facing both side walls, by cover member 316 having U-shaped in cross section of the above first arm section 310 and the base plate 314 so as to be slidable respectively (however, in FIG. 9B, since the position of the section is different, the right guide groove is not shown). The cover member 316 of the thinly formed portion in the first arm section 310 is arranged so as to insert into the cover member 322 of the second arm section 320 in a nested manner.

Further, in the first arm section 310, a pinion 318, which meshes with the rack 326, is rotatably attached to the cover member 316. The rotating shaft of the pinion 318 serves as the input shaft to a one-way brake mechanism 340 attached to the base plate 314. The one-way brake mechanism 340 comprises a plurality of friction plates and the like, and which provides no or small resistance with respect to a rotation in a certain direction, and provides a brake function with respect to a rotation in the inversed direction, and is driven by the pinion 318. Accordingly, the one-way brake mechanism 340 is arranged so as to provide such function that, when the rotation direction of the pinion 318 owing to the mesh between the rack 326 and the pinion 318 is for the extension direction of the arm section 300, a small resistance is provided; and in the direction for retraction direction, a braking function is generated. As for the one-way brake mechanism 340, a unit from market may be employed.

Within the hollow section of the arm section 300, a power and signal cable 350, which connects between the main unit 100 and the display unit 210, is contained. In this embodiment, a winding mechanism 360 for eliminating the slack of the cable 350 is also attached to the cover member 316 (refer to FIG. 7). The winding mechanism 360 has a winding dram (which is not particularly shown in the figure), and is arranged so that a gear 362 meshed with the pinion 318 drives the winding dram. According to this embodiment, since the cable 350 is contained within the hollow section of the arm section 300, the performance of visual appearance is not decreased and the cable 350 is prevented from being entwined.

Further, referring mainly to FIGS. 8A and 8B, FIG. 9A and FIG. 9C, the hinge mechanism H1, which rotatably connects the first arm section 310 of the telescopic arm section 300 and the rear end portion of the main unit 100, and the hinge mechanism H2, which rotatably connects the second arm 320 and the back portion of the lid section 200 will be described.

As common components, the hinge mechanism H1 and the hinge mechanism H2 comprises a hinge shaft HS having a head section to which a first mounting bracket HB1 is fixed, a second mounting bracket HB2, into which the hinge shaft HS is inserted, is rotatable around the axis, a spring HSP for pressing a friction member against the second mounting bracket HB2 and a nut HN screwed on the hinge shaft HS for adjusting the friction force. In the hinge mechanism H1, the first mounting bracket HB1 is mounted on the base plate 314 of the first arm section 310 with a screw or the like, and the second mounting bracket HB2 is mounted on a mounting plate 313, which fixed to the main unit 100. On the other hand, in the hinge mechanism H2, the first mounting bracket HB1 is mounted on the frame plate 324 of the second arm 320, the second mounting bracket HB2 is mounted on a mounting plate 323, which is fixed to the bottom face of the pocket 220 in the rear portion of the lid section 200.

Thus, between the main unit 100 and the arm section 300, owing to the hinge mechanism H1; and between the arm section 300 and the lid section 200, owing to the hinge mechanism H2, by adjusting the friction force, it is possible to adjust the angle a small amount and to maintain the angle.

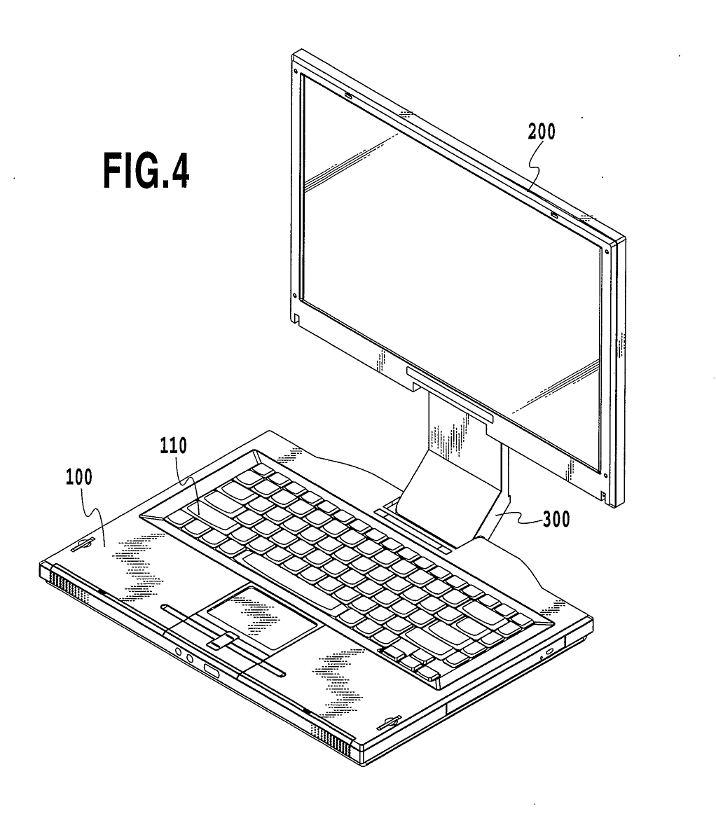

In the first embodiment of the invention having the above-described arrangement, when the lid section 200 is opened from the state that the lid section 200 is closed as shown in FIGS. 1 and 2 to the state shown in FIG. 3A, the arm section 300 is turned along with the lid section 200 via the hinge mechanism H1, which is adjusted to an appropriate friction force. From this state, to adjust the position of the display unit 210 to a higher position, the lid section 200 is held and simply lifted up. Then, as shown in FIG. 6, the arm section 300 is extended, and the lid section 200 leaves the rear end of the main unit 100 to a higher position as shown in FIGS. 4, 5 and 6. When extending the arm section 300, as described above, the one-way brake mechanism 340, which is driven by the pinion 318 meshed with the rack 326 provides non or a small resistance. Accordingly, the lid section 200, and further, the display unit 210 can be readily positioned at a desired height.

At this desired position, when the lid section 200 is released, owing to the weight of the lid section 200 itself, the pinion 318 meshed with the rack 326 is driven in the inversed direction. However, the one-way brake mechanism 340 provides the brake function against the rotation in the inverted direction. Accordingly, the lid section 200 is not moved by the force due to the weight of the lid section 200 itself; thus the lid section 200 is reliably held at the above-described desired height position.

As shown with an imaginary line in FIG. 6, at the above-described desired height position, owing to the hinge mechanism H2, the angle of the lid section 200 can be preferably changed. At the same time, by using the hinge mechanism H1 along with the hinge mechanism H2, the lid section 200, and further, the display unit 210 can be positioned at various angles. In the various positions as described above, owing to the hinge mechanism H1 and the hinge mechanism H2 having an appropriate friction force respectively, it is needless to say that the lid section 200 is reliably held.

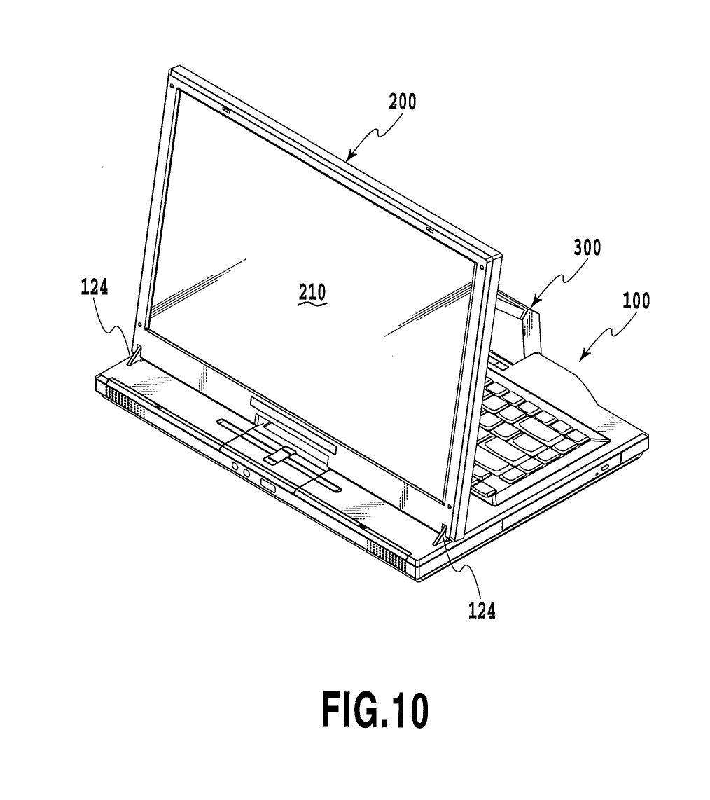

Now, as one of the above-described various positions of the lid section 200, an operation to position the lid section 200 to the same state as that of an ordinary TV set as shown in FIGS. 10, 11 and 12 will be described. In this case, in the state that the arm section 300 is extended as described above, utilizing an inflated portion in the central area of the slot 122 of the locking means 120, the locking bracket 124 is nipped by fingers and raised therefrom. And the lid section 200 is shifted so that the tip portion of the raised locking bracket 124 enters into the slot 232 formed in the lower edge portion of the lid section 200. Then, the detent ball 234, which is urged by the spring 236 to freely come out and retract, engages with ball socket 127 at the tip end of the locking bracket 124, of which rotation angle is limited; and thus, the lower edge portion of the lid section 200 is locked. In this state, the lid section 200 fitted with the display unit 210 hides the upper surface of the main unit 100. Accordingly, extra portion such as keyboard 110 does not come into the field of vision resulting in the notebook type PC, which is the same as an ordinary TV set. In this state that the lower edge portion of the lid section 200 is locked, using the junction portion of the detent ball 234 at the lower edge portion and the ball socket 127 as the center, by adjusting the length of the arm section 300 and the angle of the hinge mechanisms H1 and H2, the tilt angle of the display unit 210 can be set freely. That is, the display unit 210 can be raised up at right angle or an angle close to right angle with respect to the main unit 100 resulting in the state same as that of an ordinary TV set.

Furthermore, it may be arranged so that the slide mechanism in the above-described arm section 300 is driven by an electric motor such as a step motor. In this case, it may be arranged so that, in place of the above-described one-way brake mechanism 340, an electric motor is provided to directly drive the pinion 318. By controlling the electric motor using control commands, the lid section 200, and further the display unit 210 can be selectively set to a desired height while viewing it.

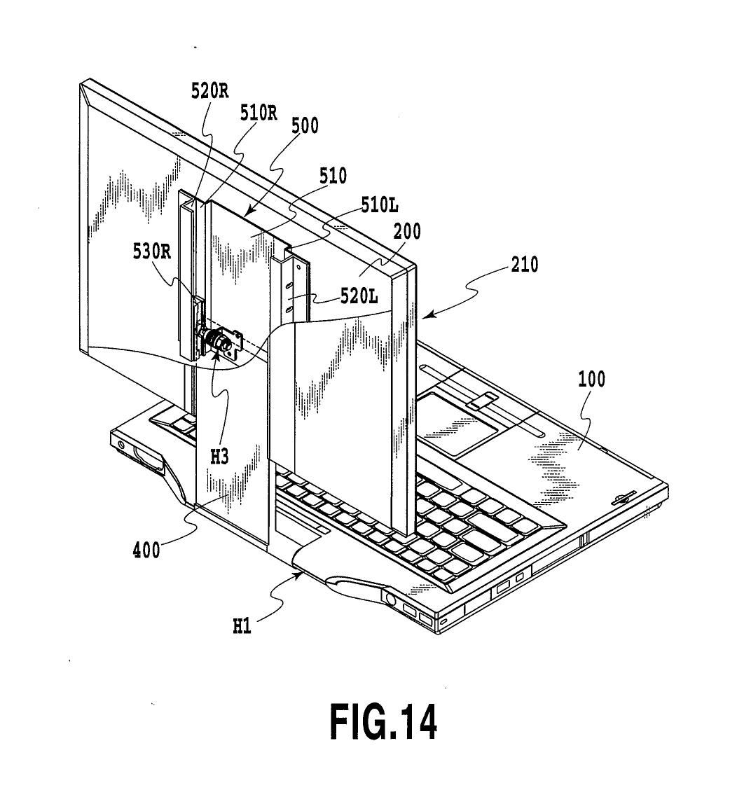

Next, a second embodiment of the present invention will be described with reference to FIGS. 14-16. The above-described notebook type PC 10 in accordance with the first embodiment comprises the main unit 100, the lid section 200 fitted with the display unit for covering the main unit 100, and the telescopic arm section 300, of which one end is rotatably pivoted in the rear end portion of the main unit 100 and the other end thereof is rotatably pivoted in the rear portion of the lid section 200. On the other hand, a notebook type PC 10 in the second embodiment comprises a main unit 100, a lid section 200 fitted with the display unit for covering the main unit 100 and an arm section 400, of which one end is pivoted rotatably in the rear end portion of the main unit 100 and the other end is pivoted rotatably in the rear portion of the lid section 200 being interposed by a slide mechanism 500, which is provided so as to slide thereon. Accordingly, in the following description of the second embodiment, only the structure different from the above-described first embodiment will be described. The parts and functions, which are the same as those in the first embodiment, will be given with the same reference numerals and the redundant description thereof will be omitted. In the following descriptions also, when indicating the positional relationship such as “upper” and “lower” or the “right” and “left” direction, same as the description of the previous embodiment, a state in which a lid section is opened with respect to the main unit is used as the reference; and it is defined that the side of the display unit facing to an operator is the front side thereof.

As described above, the lid section 200, which covers the main unit 100 when it is not used, is fitted with the display unit 210 comprised of a liquid crystal display and the like on the front side thereof. FIG. 14 shows a state that the lid section 200 is opened. In the second embodiment, a slide mechanism 500 is disposed at the central area on the rear face of the lid section 200. The slide mechanism 500 comprises a base plate 510 having substantially a hat-like cross section attached to the rear face of lid section 200 being embedded therein, right and left rail members 520L and 520R connected to right and left edge portions 510L and 510R to constitute right and left guide rails having substantially U-like cross section, and right and left sliders 530L and 530R made of resin fitted to the right and left guide rails so as to slide thereon. A leaf spring and the like is formed integrally by integral molding or separately attached to the one face of the rectangular parallelepiped sliders 530L and 530R so as to provide an appropriate friction force to the sliding faces between the rail members 520L, 520R and the same.

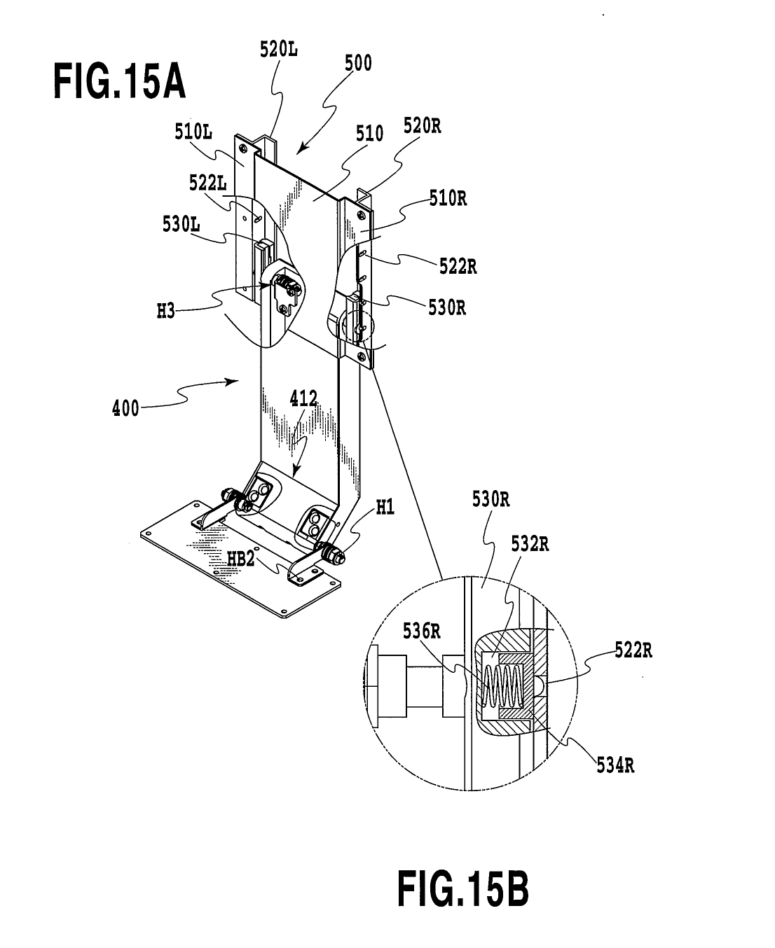

On the other hand, the arm section 400 is pivoted rotatably at one end thereof by the above-described hinge mechanism H1 in the rear end portion of the main unit 100; and is pivoted rotatably at the other end thereof to the right and left sliders 530L and 530R of the above-described slide mechanism 500 by a hinge mechanism H3, which has the same structure as that of the hinge mechanism H1. When the notebook type PC 10 is not used and the lid section 200 covers the main unit 100 as shown in FIGS. 1 and 2, in order to allow the lid section 200 and the main unit 100 to be parallel to each other, the arm section 400 is formed with a clearance 412 as a bending portion same as the previous embodiment (refer to FIGS. 15A and 15B).

Further, the above mentioned slide mechanism 500 is provided with a holding means for holding at least one of the right and left sliders 530L and 530R at a predetermined position. The holding means is comprised of a detent mechanism. In particular, dimples or holes 522L and 522R are formed at predetermined intervals in the bottom portion of at least one of the right and left rail members 520L and 520R constituting a pair of right and left guide rails. On the other hand, in the right and left sliders 530L and 530R, guide holes 532L and 532R are formed. In the guide holes 532L, 532R, slide pins 534L, 534R with detent ball are provided respectively so as to come out and retract being urged by springs 536L, 536R.

In the second embodiment also of the present invention, which has the structure as described above, when the lid section 200 is opened from the closed state as shown in FIGS. 1 and 2 to the open state shown in FIG. 3A, the arm section 400 is rotated along with the lid section 200 via the hinge mechanism H1, which is adjusted to an appropriate friction force. From this state, when the display unit 210 is adjusted to a higher position, the lid section 200 is held by fingers and simply lifted up. Then, as shown in FIG. 14, the sliders 530L, 530R supported by the end portion of the arm section 400 is guided by the right and left guide rails and the lid section 200 is separated from the rear edge portion of the main unit 100 and is shifted to a higher position. When adjusting the height of the lid section 200, owing to an appropriate friction force given to the sliding faces between the sliders 530L, 530R and the rail members 520L, 520R, the lid section 200 as well as the display unit 210 can be positioned at a predetermined height without chattering.

In this predetermined position, the slide pins 534L, 534R with detent ball, which are provided in the guide holes 532L, 532R formed in the slider 530L, 530R being forced by the springs 536L, 536R, engage with any one of the holes 522L, 522R formed in the rail members 520L, 520R at predetermined intervals to prevent the lid section 200 from moving. By carrying out the above-described operation on the other holes 522L, 522R, the lid section 200 and the display unit 210 accordingly can be held reliably at a predetermined height position.

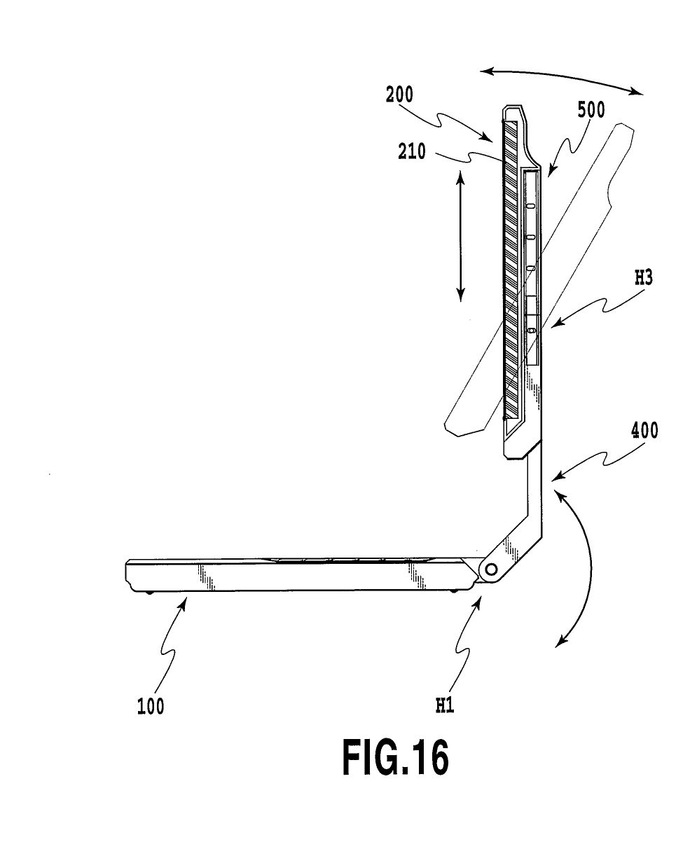

Also, as shown with imaginary line in FIG. 16, at a desired height position as described above, the angle of the lid section 200 can be changed desirably using the hinge mechanism H3. Likewise, same as the previous embodiment, by using the hinge mechanism H1 together, the lid section 200 and the display unit 210 accordingly can be positioned at various angles. It is needless to say that, owing to the hinge mechanism H1 and the hinge mechanism H3, which have an appropriate friction force, the lid section 200 can be held reliably at various positions.

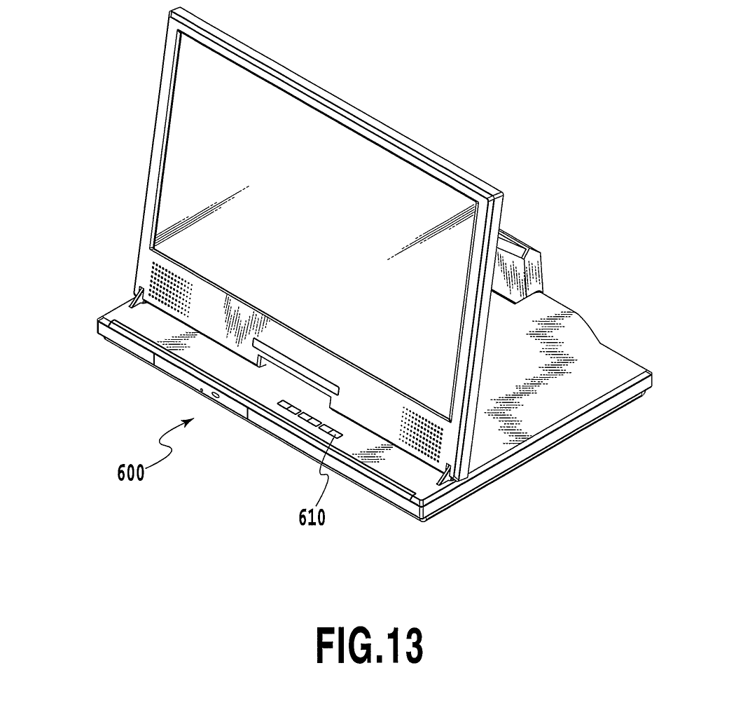

As described above, the embodiment of the present invention, which is applied to the notebook type PC, has been described. However, the present invention is not limited to the above-described embodiment, but needless to say, applicable to other portable electronic apparatus. For example, the present invention is applicable to a portable type DVD display 500 as shown in FIG. 13. The portable type DVD display 600 is a video reproducing apparatus, which has, in place of the keyboard of notebook type PC, keys 610 only necessary for reproducing the video and the like. This reproducing apparatus is also, when being carried around, folded like the notebook type PC. And when watching, as shown in FIG. 13, the lid section 200 fitted with the display unit 210 can be locked at a front lower edge portion, and the angle thereof can be adjusted. By adjusting the angle, the user can enjoy the reproduced video with a relaxed posture easy to watch it.

Further, in the above-described embodiment of the notebook type PC, a change-over switch, which is functioned when the detent ball 234 at the lower edge portion of the lid section 200 is engaged with the ball socket 127 of the main unit 100, may be provided so that the display is switched automatically from the PC monitor screen to a TV screen. By adopting this arrangement, the operation can be further simplified.

The present invention has been described in detail with respect to preferred embodiments, and it will now be apparent from the foregoing to those skilled in the art that changes and modifications may be made without departing from the invention in its broader aspect, and it is the intention, therefore, in the apparent claims to cover all such changes and modifications as fall within the true spirit of the invention.

1. A portable electronic apparatus, comprising:
a main unit,
a lid section fitted with a display unit for covering said main unit, and
an arm section pivoted rotatably at one end thereof in a rear end portion of said main unit for supporting said lid section rotatably and adjustably in height position.

2. The portable electronic apparatus according to claim 1, wherein said arm section is telescopic.

3. The portable electronic apparatus according to claim 2, wherein said main unit is provided with, in an upper portion on a front end side thereof, locking means for locking a lower edge portion of said lid section.

4. The portable electronic apparatus according to claim 2, wherein said arm section has a clearance for, when said lid covers said main unit, allowing the both to be parallel to each other.

5. The portable electronic apparatus according to claim 2, wherein said arm section includes a slide mechanism and a one-way brake mechanism that provides a small resistance in the extension direction of the arm section and a brake force in the retraction direction thereof.

6. The portable electronic apparatus according to claim 5, wherein said arm section contains a cable for connecting said main unit and said display unit, and has a winding mechanism for the cable.

7. The portable electronic apparatus according to claim 5, wherein said arm section comprises a first arm section on said main unit side and a second arm section on said lid section side, said slide mechanism includes a rack, which is attached to one of either the first arm section or the second arm section, and a pinion, which is rotatably attached to the other of either the first arm section or the second arm section so as to mesh with the rack; and the one-way brake mechanism, which provides a small resistance in the extension direction of said arm section and a brake force in the retraction direction thereof, is driven by the pinion.

8. The portable electronic apparatus according to claim 7, wherein the winding mechanism of said cable is driven by said pinion.

9. The portable electronic apparatus according to claim 5, wherein said slide mechanism is driven by an electric motor.

10. The portable electronic apparatus according to claim 3, further comprising a changeover switch, which functions when the lower edge portion of said lid section is locked by said locking means.

11. The portable electronic apparatus according to claim 2, wherein said lid section includes a substantially rectangular shaped pocket formed in the rear portion, and said telescopic arm section includes the first arm section on said main unit side and a second arm section on said lid section side; the first arm section can be accommodated in the second arm section in a nested manner, and the second arm section can be accommodated by said pocket.

12. The portable electronic apparatus according to claim 11, wherein said main unit includes a locking means for locking the lower edge portion of said lid section to the upper portion on the front end side thereof.

13. The portable electronic apparatus according to claim 12, wherein said locking means is comprised of a locking bracket having a ball socket at a tip end thereof provided, to be rotatable within a predetermined angle, in slots formed at both sides in the upper portion on the front end side of said main unit, and a detent ball provided in slots formed in the lower edge portion of said lid section can engage with the ball socket.

14. The portable electronic apparatus according to claim 1, wherein said arm section is pivoted rotatably at the other end thereof through a slide mechanism slidably provided in the rear portion of said lid section.

15. The portable electronic apparatus according to claim 14, wherein said main unit includes a locking means for locking the lower edge portion of said lid section in the upper portion on the front end side thereof.

16. The portable electronic apparatus according to claim 15, wherein said arm section has a clearance for, when said lid covers said main unit, allowing the both to be parallel to each other.

17. The portable electronic apparatus according to claim 15, wherein said slide mechanism includes a pair of guide rails provided in the rear portion of said lid section and a pair of sliders which slide along the pair of guide rails respectively, and further includes a holding means for holding the slider at a predetermined position.

18. The portable electronic apparatus according to claim 17, wherein said holding means includes dimples formed at predetermined intervals in at least one of said pair of guide rails and a detent ball provided in said slider.

19. The portable electronic apparatus according to claim 15, further comprising a change-over switch, which functions when the lower edge portion of said lid section is locked by said locking means.

20. The portable electronic apparatus according to claim 14, wherein said lid section has a pocket of a substantially rectangular shape formed in the rear portion, and said arm section can be received in the pocket.

21. The portable electronic apparatus according to claim 14, wherein said locking means is comprised of a locking bracket having a ball socket at a tip end thereof provided, to be rotatable within a predetermined angle, in slots formed at both sides in the upper portion on the front end side of said main unit, and a detent ball provided in the slots formed in the lower edge portion of said lid section can engage with the ball socket.
